(19) United States
(12) Patent Application Publication
(10) Pub. No.: US 2005/0252011 A1
(43) Pub. Date: Nov. 17, 2005

(54) Guide adapter with claw contour

(76) Inventor: Michael Neumeier, Steingaden (DE)

Correspondence Address: DAVID TOREN, ESQ.;ABELMAN FRAYNE & SCHWAB, 666 THIRD AVENUE, NEW YORK, NY, 10017-5621, US

(21) Appl. No.: 11/128,747

(22) Filed: May 12, 2005

(30) Foreign Application Priority Data
May 14, 2004 (DE) 10 2004 024 092.2

(51) Int. Cl. B27B 21/08

(52) U.S. Cl. 30/371

(57) ABSTRACT

A guide adapter (18) has carrier means removably secured on a tool-side end of a housing (4) of a saber saw (2) and a contacting element (16) for contacting on a work piece (32) to be worked. The contacting element (16) has a claw contour for securing on a surface (30) of the work piece (32). The carrier means has a clamping contour for immobile clamping on the housing (4) and the claw contour is transiently affixed relative to the carrier means. The claw contour has a plurality of teeth (28), which are directed away from the carrier means.

### BACKGROUND OF THE INVENTION

The invention relates to a guide adapter with carrier means for removable attachment to a tool-side end of a housing of a saber saw. Moreover, the guide adapter has a contact element for contacting a work piece to be worked on, wherein the contact element is provided with a claw contour for attaching to a surface of the work piece. Further, the invention relates to a saber saw with this type of guide adapter.

This guide adapter having a claw contour is used primarily for immobilizing a saber saw on a work piece to be worked on comprised of softer material into which the claw contour can partially penetrate to prevent slipping. Such work pieces can be broken parts made of wood or tree branches.

U.S. Pat. No. 6,484,409 discloses a saber saw, whose neck holds a guide adapter. A displaceable hook element is arranged on a guide element on the guide adapter, wherein a claw contour is formed on said hook element. In this case, the teeth of the claw contour project in the cutting direction. When applying the saber saw to a branch to be cut, the branch is clamped between the claw contour and the guide element. During the cutting operation, the hook element is urged along the guide element against a spring force, whereby the saw blade penetrates increasingly into the branch to be cut.

This type of process provides for good guiding especially when cutting work pieces with a round cross-section. For other demolition work such as reducing wooden walls, the prior art guide adapter is unsuitable because of the limited displacement path of the hook element. In addition, a high pressure must be applied when sawing because the spring fore acting on the hook element must be overcome and the pressure necessary for advancing the saw blade must be applied. To produce this high pressure, the end of the saber saw opposite to the saw blade must be drawn upwards with the first hand while the device neck must be urged downwards with a second hand. A relatively high pressure of the saw blade against the work piece results from the torque generated in this process.

### SUMMARY OF THE INVENTION

The object of the present invention is to avoid the aforementioned drawbacks and to provide a saber saw for more convenient demolition work.

According to the invention, this object is achieved by a carrier means having a clamp contour for immobile clamping on the housing and the claw contour being transiently secured relative to the carrier means, whereby the claw contour has a plurality of teeth, which are directed away from the carrier means on the free face of the contacting element. By virtue of this configuration of the guide adapter, the useful mechanical advantage of the saber saw in the cutting operation is clearly extended since it extends from the posterior end of the saber saw, which faces away from the saber saw, over the housing and the carrier means to the contacting element. At the same time, the pivot point, about which the extended mechanical advantage acts, is died by the contacting element, which with the aid of the claw contour is automatically held on the work piece. In this manner, the counter-pressure required for generation of the torque is generated solely by the engagement of the claw contour on the work piece. The pressure necessary for advancing the saw blade can then be generated solely by raising the posterior end of the saber saw. Accordingly, it is now possible to generate the pressure of the saw blade on the work piece with only one hand.

Advantageously, the teeth are arranged in two parallel rows, wherein the hold of the toothed contour on the surface of the work piece and the guiding of the saw blade are improved.

Preferably, the contacting element is fastened rigidly to the carrier means. In this manner, a maximum length of the useful mechanical advantage is obtained, which reaches from the posterior end of the saber saw over its housing, the carrier means and the contacting element onto the claw contour. In this manner, the pivot point, about which this maximum mechanical advantage acts, is defined by the tips of the teeth that grip into the surface of the concerned work piece. A high contact pressure of the saw blade against the work piece can be obtained comfortably.

When this is done, the teeth are advantageously arranged along an arcuate path, whereby a certain rolling travel of the teeth on the work piece occurs when generating the torque around the tooth contour. his rolling travel of the tooth contour provides a sufficient hold of the contacting element on the work piece at all times during the cutting operation.

When this is done, the teeth are preferably arranged along a circular path, whose radius is in a range from 10 to 30 cm, in particular 20 cm, whereby the torque about the tooth control can be generated comfortably.

In an alternative embodiment, the contacting element is pivotally mounted on the carrier means about a pivot axis. When this is done, the majority of the teeth permanently contact the work piece during the cutting operation. A particularly secure positioning of the contacting element on the surface of the work piece is achieved in approximately the maximum length of the useful mechanical advantage.

Furthermore, the carrier means advantageously have two rods arranged parallel to each other for insertion into appropriately formed receptacles in the saber saw. In this case, at least one engagement recess is formed on each of the rods for partially receiving a locking element, which serves to axially secure the rods in the receptacles.

It is particularly advantageous, if the rods have at least two engagement recesses in the axial direction. In this manner, the spacing of the contacting element to the saber saw and the length of the useful mechanical advantage can be adapted to a planned cutting operation.

### BRIEF DESCRIPTION OF THE DRAWINGS

The invention will be more completely described with reference to the drawings wherein:

FIG. 1 represents a side view of a saber saw with a guide adapter according to the invention;

FIG. 2 represents a perspective view of the guide adapter of FIG. 1, and

FIG. 3 represents a perspective view of an alternative guide adapter according to the invention.

### DETAILED DESCRIPTION OF THE INVENTION

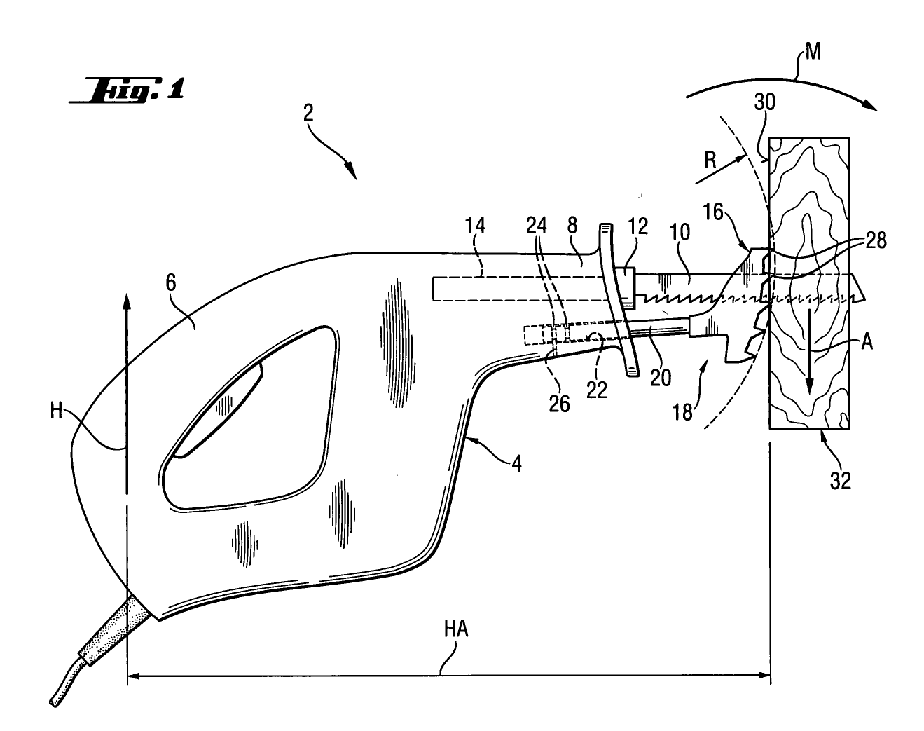

FIG. 1 shows a saber saw 2 with a housing 4. A main handle grip 6 is formed at a posterior end of housing 4. At a tool-end facing away form the posterior end, the housing 4 forms a device neck 8, which serves as an additional hand grip.

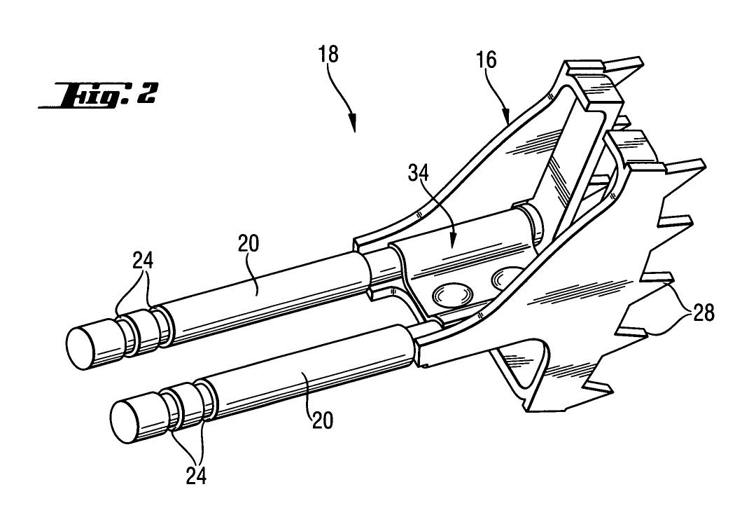

At a free end of the device neck 8, a saw blade 10 projects from the housing 4, which is fastened using a tool receptacle 12 on a tool spindle 14 of the saber saw 2. The saw blade 10 passes through a contacting element 16 of a guide adapter 18, which is represented in FIG. 2 separated from the saber saw.

The guide adapter 18 can be secured at the device neck 8 of the saber saw 2 using carrier means such as two rods 20 arranged parallel to each other and having a round cross-section. For securing, the rods 20 are inserted into hollow cylindrical receptacles 22 on the device neck 8. The hollow cylindrical receptacles 22 thus form a free cross-section, which corresponds to the cross-section of the rods 20.

For axial securing in the cylindrical receptacles 22, two engagement recesses 24 in the form of constrictions are formed on each rod 20. A mobile locking element 26 engages into one of these engagement recesses 24. Depending on which of the two engagement recesses 24 the locking element 26 engages, the contacting element 16 is spaced from the housing 4.

The round cross-section of the rods 20 and the engagement recesses 24 thus form a clamping contour of the carrier means, which makes their clamping on the device neck 8 possible.

Further, as can be seen in FIGS. 1 and 2, the contacting element 16 has a claw contour with a plurality of teeth 28. The teeth 28 are arranged on the front surface on the contacting element 16; in other words, they are directed axial to and away from the rods 20 and in the contacting condition also away from the saber saw 2. The tips of the teeth 28 are arranged in two parallel rows, each along a virtual arch having a radius R, which is in the range from 10 to 30 cm, in particular 20 cm.

In the cutting operation, the contacting element 16 is applied on a work piece 32 to be worked. When this is done, the teeth 28—as represented in FIG. 1—partially penetrate into the surface 30 of the work piece 32 and secure the guide adapter 18 on the work piece 32 opposite to the working direction A. By raising the posterior end of the saber saw 2 in the stroke direction H, with a maximum mechanical advantage HA, which reaches from the tips of the teeth 28 penetrating into the work piece to the end of the saber saw 2, a relatively large moment M is generated about the penetrating tips. Again, a higher contact pressure of the saw blade 10 against the work piece 32 in the working direction A results from this moment.

As can be seen in FIG. 2, the contacting element 16 is fastened using fastening means 34 to the two rods 20 (carrier means). Alternatively, the contacting element 16 and the carrier means can be configured in one piece.

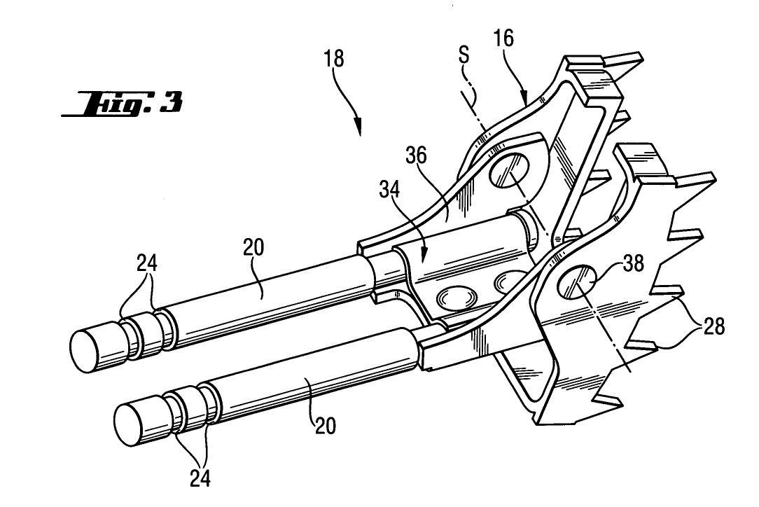

FIG. 3 represents an alternative embodiment of the guiding adapter 18, in which the contacting element 16 is held pivotally about a pivot axis at the rods 20. In this case, the contacting element 16 is connected to the rods 20 using an intermediate element 36 and the fastening means 34, wherein the contacting means 16 is mounted pivotally at the intermediate element 36 via pins 38.

1. A guide adapter (18) having carrier means for being removably secured on a tool-end of a housing (4) of a saber saw (2) and a contacting element (18) for contacting a work piece (32) to be worked, wherein the contacting element (16) has a claw contour for securing on a surface (30) of the work piece (32), wherein the carrier means has a clamp contour for clamping the housing (4) and the claw contour is transiently affixed relative to the carrier means, and wherein the claw contour has a plurality of teeth (28) that are directed away from the carrier means.

2. The guide adapter of claim 1, wherein the teeth (28) are arranged in two parallel rows.

3. The guide adapter of claim 1, wherein the contacting element (16) is affixed rigidly to the carrier means.

4. The guide adapter of claim 3, wherein the teeth (28) are arranged along an arcuate path.

5. The guide adapter of claim 4, wherein the teeth are arranged along a circular path having a radius (R) in a range from 10 to 30 cm.

6. The guide adapter of claim 1, wherein the contacting element (16) is mounted on the carrier means pivotally about a pivot axis (S).

7. The guide adapter of claim 6, wherein the carrier means has two rods (20) arranged parallel to each other for insertion into corresponding receptacles (22) of the saber saw (2), wherein an engagement recess (24) is formed on each of the rods (2) for partially receiving a locking element (26).

8. The guide adapter of claim 7, wherein the rods (20) have at least two engagement recesses (22) in the axial direction.

9. A saber saw (2) having a guide adapter (18) having carrier means for being removably secured on a tool-end of a housing (4) of a saber saw (2) and a contacting element (18) for contacting a work piece (32) to be worked, wherein the contacting element (16) has a claw contour for securing on a surface (30) of the work piece (32), wherein the carrier means has a clamp contour for clamping the housing (4) and the claw contour is affixed opposite to the carrier means, and wherein the claw contour has a plurality of teeth (28) that are directed away from the carrier means.

10. The guide adapter of claim 5, wherein the Radius (R) is 20 cm.
